(19) United States
(12) Patent Application Publication
(10) Pub. No.: US 2004/0004956 A1
(43) Pub. Date: Jan. 8, 2004

(54) Apparatus and method for routing information from a telecommunications network

(75) Inventors: Bruce Gilmour, Fife (GB); James Galloway, Scone (GB)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 10/189,356

(22) Filed: Jul. 3, 2002

(51) Int. Cl. H04L 12/66; H04L 12/56

(52) U.S. Cl. 370/352; 370/389; 370/400

(57) ABSTRACT

A data processing apparatus (3) is coupled to receive messages from a telecommunications network (1), in order to collate messages relating to the same transaction into a transaction record for further analysis. The apparatus (3) receives messages from the networks having different formats (protocols). For each input message, a data packet processing module (7) including a data packet routing module (8) and a memory 9, in which is stored a predetermined set of routing rules, compares the contents of one or more fields or subfields in the message with the routing rules in order to determine a destination for each message. The data packet routing module 8 thus routes the messages according to the routing rules to different subsequent processing modules (10), such as transaction builders, or to none of them, if the routing rules are not met. The routing rules allow filtering out unwanted signaling, creation of streams of related signaling and load balancing those streams across processors that will build transactions or otherwise process the data stream.

### FIELD OF THE INVENTION

This invention relates to an apparatus and method for routing information gathered from a telecommunications network, particularly, though not exclusively, to an apparatus and method for routing information relating to different transactions on the network for analysis.

### BACKGROUND OF THE INVENTION

In modern switched telecommunications systems (in particular, modern Public Switched Telephone Networks (PSTNs) and Public Land Mobile Networks (PLMNs)) it has become common practice to provide two related but separate network infrastructures: a bearer or transmission network for carrying end-user voice and data traffic, and a signalling network for controlling the setup and release of bearer channels through the bearer network in accordance with control signals transferred through the signalling network (sometimes known as out-of-band signalling). In practice, such signalling networks comprise high-speed computers interconnected by signalling links; computer programs control the computers to provide a set of operational and signalling functions in accordance with a standardised protocol.

One example of such a signalling protocol is the Signalling System No. 7 (SS7), whether as specified by the CCITT, ANSI, ETSI (for GSM), Bellcore or similar body, such as a network being herein referred to as an SS7 network. Another known signalling protocol is the General Packet Radio Service Tunneling Protocol (GTP) used in the General Packet Radio Service (GPRS), such as is used for GSM data traffic. As is known in connection with such networks, signalling information is passed over the signalling links to carry out particular signalling conversation, or transaction. Any particular transaction requires a number of messages to be sent between two nodes in the network (endpoints of the transaction). A transaction can either carry out a procedure, such as to create a context identifier, or for hand-off control, or can request information, for example, to provide capability information. A context is a unique transaction between two end nodes that can be identified by a context identifier included in all messages relating to that transaction.

Both the SS7 and the GPRS signalling protocols belong to a class of signalling protocols characterised as consisting of a number of call models (transactions) built from a subset of messages defined by the protocol. Some of the signalling protocols in this class can be distinguished in that the messages in a call model utilise a single transactional key to uniquely identify a message belonging to the same context between the end points involved in the transaction. For example in the single key SS7 protocol the key is often a machine generated 32 bit number, whereas the GPRS Tunnelling Protocol (GTP) uses the GSM IMSI identifier plus one further digit to provide some 16 possible different contexts for a single IMSI. Of course, individual protocols may have different rules for re-transmission of messages during a transaction and the conditions that must be met in order to declare a transaction as being completed successfully, completed with an error, or timed out (abandoned). Other protocols (such as those carried on the TCAP layer) may use two transactional keys (one allocated by the originator and the other allocated by the responding node) to facilitate multiple, extended “signaling conversations”.

In order to analyse a network's operation to determine whether it is operating efficiently, it is known to analyse individual messages to determine the quality of service according to whether the messages are delayed, require re-transmission, etc. However, in order to fully determine the health of a network, it is necessary not only to consider each individual message, but also to look at a complete conversation, or transaction, which requires that all context information be available for the analysis. For example, although within a context each of the messages may be transmitted efficiently and correctly, one or more of the messages, while correct in themselves, may mean that the transaction has failed if the message states that, for example, the password is incorrect, or that an address was entered incorrectly or that a node was temporarily unavailable. In such cases, knowledge of the complete transaction that failed may allow the failures to be analysed so that the functionality of the network can be improved.

It is therefore necessary to gather together all the messages to build a complete transaction for further analysis. It is known to provide such a transaction builder for particular signalling protocols, as well as to have a number of different transaction builders available, so that transactions in different protocols can be properly collected together. Such known transaction builders rely on knowledge of the call models in particular protocols to facilitate the gathering of all the messages relating to a particular transaction. For example, particular call models would involve particular sequences of messages from one end point of the transaction to the other end point in a particular predetermined sequence, so that knowledge of the call model would allow messages in that particular sequence to be looked for during the gathering process. Nevertheless, each transaction builder for a particular protocol needs to have the capacity to look at all messages on the network and to be able to collate all messages for all the transactions that are relevant to the analysis that is to be performed.

### BRIEF SUMMARY OF THE INVENTION

The present invention therefore seeks to provide a method and apparatus for routing information from a telecommunications network, which overcomes, or at least reduces the above-mentioned problems of the prior art.

Accordingly, in a first aspect, the invention provides an apparatus for routing information gathered from a telecommunications network, the apparatus comprising a receiving element for receiving messages gathered from a telecommunications network, each message being formatted in a predetermined protocol having at least one field providing data relating to a particular transaction on the telecommunications network and other information relating to that particular transaction, a message identification module coupled to the receiving element for identifying discrete messages, a field identification module coupled to the message identification module for identifying said at least one field within each discrete message, a memory for storing a predetermined set of rules for routing messages according to data within a message, and a routing module, coupled to the memory and to the field identification module, for comparing the contents of said at least one field of a discrete message with at least one of the rules of the predetermined set of rules and for routing the message to one of a plurality of outputs or to no output, depending on a result of the comparison.

In a preferred embodiment, the field identification module identifies a plurality of predetermined fields in each message. Preferably, the predetermined set of rules defines a plurality of subsets of rules, each subset of rules being for comparison with the contents of a different field in the message.

The routing module preferably carries out the comparison on one or more of the rules in a predetermined order whereby, if a message is routed to an output as a result of a comparison, no further comparisons with further rules are made.

In a preferred embodiment, the predetermined set of rules includes a plurality of rules in a predetermined sequence and said routing module compares the contents of the at least one field of a discrete message to a first rule in the sequence and, if the message is not routed to an output as a result of that comparison, compares the contents of the at least one field of a discrete message to a next rule in the sequence.

If the contents of the at least one field of a discrete message has been compared to all the rules in a sequence without the message having been routed to an output as a result of any of those comparisons, then the message is preferably not routed to any output and is discarded.

The predetermined set of rules preferably defines a decision tree for determining to which one of a plurality of outputs the message is to be routed.

According to a second aspect, the invention provides a method of routing information gathered from a telecommunications network, the method comprising the steps of receiving messages gathered from a telecommunications network, each message being formatted in a predetermined protocol having at least one field providing data relating to a particular transaction on the telecommunications network and other information relating to that particular transaction, identifying discrete messages, identifying said at least one field within each discrete message, storing a predetermined set of rules for routing messages according to data within a message, comparing the contents of said at least one field of a discrete message with at least one of the rules of the predetermined set of rules, and routing the message to one of a plurality of outputs or to no output, depending on a result of the comparison.

Preferably, the comparison step is carried out on one or more of the rules in a predetermined order whereby, if a message is routed to an output as a result of a comparison, no further comparisons with further rules are made.

The predetermined set of rules preferably includes a plurality of rules in a predetermined sequence and said comparing step comprises comparing the contents of the at least one field of a discrete message to a first rule in the sequence and, if the message is not routed to an output as a result of that comparison, comparing the contents of the at least one field of a discrete message to a next rule in the sequence.

If the contents of the at least one field of a discrete message has been compared to all the rules in a sequence without the message having been routed to an output as a result of any of those comparisons, then the message is preferably not routed to any output and is discarded.

In a preferred embodiment, the predetermined set of rules defines a decision tree for determining to which one of a plurality of outputs the message is to be routed.

The predetermined set of rules preferably defines a plurality of subsets of rules, each subset of rules being for comparison with the contents of a different field in the message.

The messages can originate from, for example, a Signalling System No. 7 (SS7) network, a GSM network, an Intelligent Network Application Part (INAP) network or an Internet Protocol (IP) network.

### BRIEF DESCRIPTION OF THE DRAWINGS

One embodiment of the invention will now be more fully described, by way of example, with reference to the drawings, of which:

FIG. 1 shows a schematic block diagram of a part of a telecommunications network incorporating an apparatus according to one embodiment of the present invention;

FIG. 2 shows a decision tree for the apparatus of FIG. 1 for routing data packets; and

FIG. 3 is a schematic diagram of the format of a standard data packet showing two different predetermined protocol types.

### DETAILED DESCRIPTION OF THE DRAWINGS

Thus, there is shown in FIG. 1 a part of an SS7 signalling network 1, which is shown schematically as a trio of signalling lines. Sense points are shown on each of the trio of signalling lines for sensing signals on the lines and copying them to an input 2 of a data processing module 3, such as a computer. The computer can be a standard type of computer having an input/output interface, memory, a processor, etc, but is shown as a set of functional blocks, although it will be appreciated that, in practice, the same physical elements may well form part of several functional blocks.

The data processing module includes a data packet frame-identifying module 4, which receives the copies of the signals sensed from the SS7 signalling network at the input 2. It will be appreciated that the copied signal comprises essentially a series of voltages, which voltages are first transformed into a digital signal, for example using an Analog-To-Digital Converter (not shown), which can be within the data processing module 3 or external thereto. The data packet frame-identifying module 4 receives the copied signal, whether in analog or digital form, and identifies frames of signals, or data packets, within the signal by identifying data values that indicate the beginning of a frame. The discrete frames or data packets are then stored, as digital signals in the memory of the computer.

Each data packet is then processed by a data field identifying module 5 to separate out the discrete data fields within a data packet. The data field identifying module 5 can access information relating to different protocols that may be present in an SS7 network, for example an ISUP protocol or an SCCP protocol, so that each discrete data packet can be easily split into its constituent data fields,

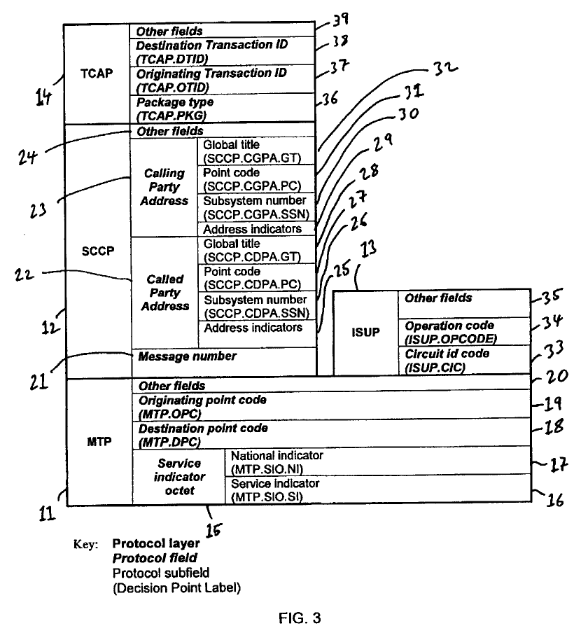

Turning now to FIG. 3, there is shown an schematic view of a standard data packet having an SS7 protocol family format. The SS7 family of protocols employs layering to allow a standard data packet format to carry different information depending on the needs of the communicating nodes. In FIG. 3, two possible stacks are shown, i.e. TCAP and ISUP. Each layer, e.g. MTP (Message Transfer Part) layer 11, SCCP (Signaling Connection Control Part) protocol layer 12 or ISUP (ISDN User Part) protocol layer 13, and TCAP (Transaction Capabilities Application Part) layer 14 consists of a set of fields, some of which may be divided into related subfields. MTP is used to perform a single hop in routing a data packet to its final destination. If the sending node has routing information for the recipient then the MTP may be used to route all the way to the final destination. Otherwise the sender will route the packet “towards” the final destination, leaving the next node to determine how best to proceed with onward routing. SCCP provides end-to-end routing. It provides a final destination address and an originator address, but the sender does not care how the data packet finds its way to the destination node which may well be in a completely separate network to the sender. ISUP is a call setup and management protocol that instructs network elements to make call connections between nodes in the network, indicate that a line is ringing, establish a connection on pick up and tear down the connection when the call ends. It also contains protocol messages for error handling and circuit management. TCAP is a complex high level protocol that allows two applications to communicate with each other e.g. to perform a database lookup in order to resolve an 800 number to an actual number that can be called. This layer provides support for actions (Invokes), responses (ReturnResult) and error handling (Error, Reject and Abort). It also specifies how to encode the parameters that are passed between the applications in actions and their responses.

In each layer there will also be one or more fields (usually at the start of the layer) that provide enough information to determine where the next layer begins and the type of information contained within. The other fields in each layer contain the information that the layer is designed to carry between communicating nodes. The information may be designed to allow the data packet to be successfully routed between nodes (usually in the lower layers—MTP and SCCP) or to invoke some action/receive results.

For example, in the MTP protocol layer 11, there is a Service Indicator Octet (SIO) field 15 that defines the protocol in the next layer above MTP using a number encoded in the SI (Service Indicator) sub field 16. It also has an indication of the national status of the message in the NI (National Indicator) sub field 17. This sub field allows the network elements to interpret the point code address as belonging to the national address space or to an alternate, possibly international, address space. The SIO.SI sub field also indicates whether the next layer is an SCCP protocol layer or an ISUP protocol layer. If the SIO.SI sub field indicates that the signaling unit is a management message then there may be other fields 20 present. The MTP layer also includes a field 18 providing a Destination Point Code (MTP.DPC) and a field 19 providing an Originating Point Code (MTP.OPC). Any single SS7 signaling unit will contain the MTP layer and either the left hand stack or the right hand stack depending on the value of the MTP.SIO.SI sub field.

If the next layer is an SCCP protocol layer 12, it may be divided into fields including a Message Number field 21, a Called Party Address field 22 and Calling Party Address field 23, as well as other fields 24. Called Party Address field 22 is further divided to include an Address Indicators subfield 25, a Subsystem Number (SCCP.CDPA.SSN) subfield 26, a Point Code (SCCP.CDPA.PC) subfield 27 and a Global Title (SCCP.CDPA.GT) subfield 28. Similarly, Calling Party Address field 23 is further divided to include an Address Indicators subfield 29, a Subsystem Number (SCCP.CGPA.SSN) subfield 30, a Point Code (SCCP.CGPA.PC) subfield 31 and a Global Title (SCCP.CGPA.GT) subfield 32.

If the next layer is an ISUP protocol layer 13, it may be divided into fields including a Circuit ID Code (ISUP.CIC) field 33 and an Operation Code (ISUP.OPCODE) field 34, as well as other fields 35.

Finally, the TCAP layer 14 may be divided into fields including a Package Type (TCAP.PKG) field 36, an Originating Transaction ID (TCAP.OTID) field 37 and a Destination Transaction ID (TCAP.DTID) field 38, as well as other fields 39.

Returning again to FIG. 1, a Data Packet Distributor module 6 distributes each of the pre-processed (at least to determine the discrete packets and fields within each packet) message to one or more Data Packet Processing Modules. Each of the data packet processing modules may process the data packets in any way they deem necessary in order to fulfil their function. In the present embodiment, one of the data packet processing modules 7 includes a data packet routing module 8. This data packet processing module 7 also includes a memory 9, in which is stored a predetermined set of routing rules and the data packet routing module 8 interprets the routing rules in order to determine a destination for each data packet. Of course, the rules can be contained within a configuration file that is loaded by the module and may be updated and reloaded at any time. The data packet routing module 8 thus routes the data packets according to the routing rules to different subsequent processing modules 10, or to none of them, if the routing rules are not met. In one example, at least some of the subsequent processing modules are transaction builders, which, as described above, collate all messages that relate to a single transaction, so that the efficiency of the system can be determined.

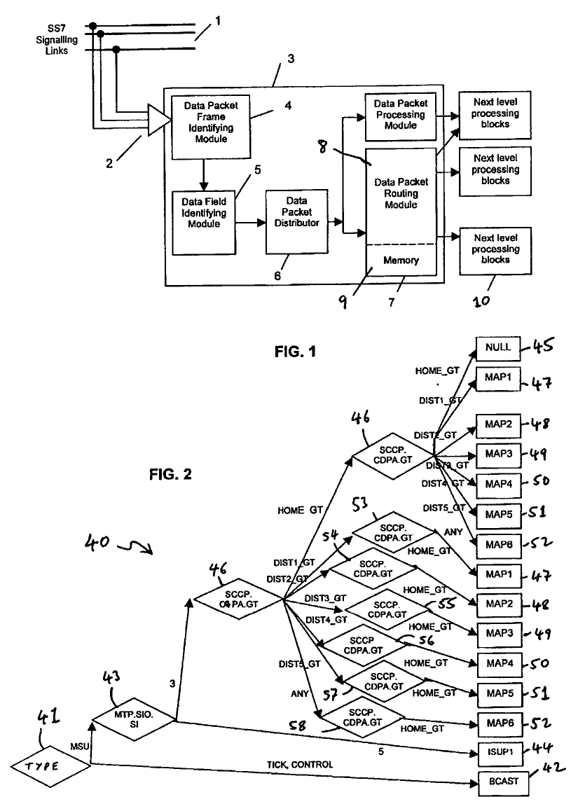

The routing rules are used to define a decision tree 40, such as the one shown schematically in FIG. 2. In this example, the diamonds are decision points, where the contents of a particular field or subfield in the data packet are compared with particular data defined in the routing rules and the data packet is then routed to the defined destination if the result of the comparison is positive. If the result is negative, the next rule in the set is used to perform the next comparison, and so on. In one scenario, a Roaming Management System monitors the international SS7 links between a customer's network (the monitored or home network) and those other networks with which it has international partnerships. In order to monitor the health of the roaming service the solution must build all of the transactions between the home network and its partners before performing measurements that provide operatives with appropriate indicators. In this scenario the traffic is routed between nodes in each network using SCCP global titles (similar to telephone numbers but acting as addresses for nodes in a network). Because the traffic load is likely to be too heavy for a single transaction builder to handle, the routing rules can be used to split the traffic at source and send individual streams of data packets to a pool of transaction builders.

In this example, the networks in each of the five largest European countries (by roamer volume) are each assigned an individual transaction builder (MAP1 through MAP5) with all other networks being handled by a single transaction builder (MAP 6). Additionally, all call setup traffic (data packets containing the ISUP protocol) are sent to a dedicated destination to be handled separately to the traffic related to roaming transactions.

Thus, referring to FIG. 2, the data packet routing module 8 is fed a continual stream of events that may be either externally or internally generated. The external events are the data packets captures from the SS7 signalling links 1. The internal events are either ticks from a timer that are used to provide a heartbeat to the subsequent processing modules 10 receiving data that is routed by the routing rules or control packets that pass information about significant events to the subsequent processing modules 10.

In the decision tree 40 the first decision point 41 is made with reference to the type of event that has been presented to the decision tree. Thus, a decision is made whether the data packet is a Message Signalling Unit (MSU). This decision point uses state information from the monitoring environment to make its decision. If not, for example in the case of ticks and control packets the data packet is routed to be broadcast 42 to all of the subsequent processing modules 10 that have been defined as destinations. Data packets that are MSUs, however, require further processing to decide where they should be routed.

Having decided that an input event is an MSU, the decision tree 40 knows that it can inspect the information in the MTP layer of the protocol stack to make further decisions. In the MTP layer, the Service Indicator subfield 16 of the Service Indicator Octet field 15 contains information that identifies the next layer in the protocol stack. In this case the decision point 43 tests for either SCCP protocol (MTP.SIO.SI=3) or ISUP protocol (MTP.SIO.SI=5). No other values are of interest to the decision point resulting in all other data packets that match neither of the two branches being discarded.

If the data packet matches the ISUP branch then it traverses the tree directly to a leaf node 44, which represents a list of destinations to which it is to be sent. In the example most of the destination lists are single destinations. It is possible, however, to specify a list consisting of a mixture of discrete destinations, destination groups and destination groups with a function call operator that takes parameter (from the protocol) that resolves to the index of one of the group members.

If the data packet matches the SCCP branch then the decision tree performs checks that are designed to ensure that either the Calling Party Global Title or the Called Party Global Title matches one of the home network global title prefixes. Where both addresses match one of the home network global title prefixes the MSU is sent to the special destination NULL 45 which results in it being discarded. Where neither address matches one of the home network global title prefixes the MSU is implicitly discarded (due to no matching branch).

Thus, in decision point 46, the Calling Party Global Title (SCCP.CGPA.GT) is compared to the various predetermined possible Global Titles. If it matches a home network prefix HOME GT, the MSU traverses the first branch. Its Called Party Global Title (SCCP.CDPA.GT) is then tested to determine which of the destinations the MSU will be sent to. As mentioned above, if it the called destination is also the home network, then the MSU is discarded since Home-To-Home calls are not of interest. If the Called Party Global Title is one of the predetermined destinations of one of the five largest European countries, then the MSU is passed to the appropriate individual transaction builder (MAP1 through MAP5) 47-51 with all other networks being handled by a single transaction builder (MAP 6) 52.

On the other hand, if, in decision point 46, the Calling Party Global Title doesn't match a home network prefix then it is tested against the branches indicating the network prefixes of the five largest European countries (or any other network) to find the one that does match. Once the appropriate branch has been identified the Called Party Global Title is tested, in decision points 53-58 only against the home network prefixes HOME GT in order to ensure that any MSUs containing no home network address are discarded.

The special decision value ANY is used as a catch all for values that didn't match any previous branch. Since the tree is constructed in the same order as the rules are specified, ANY should be the last branch to be tested at any given decision point. Placing it in a position prior to last will result in the subsequent branches never being tested.

Thus, the particular decision tree shown in FIG. 2 routes MSUs between a Home network and any one of five predefined foreign networks to particular transaction builders to be further processed, with any MSUs between the Home network and a different foreign network being routed to a different transaction builder whereas all MSUs solely on the Home or a foreign network or between different foreign networks are discarded.

The routing rules thus allow filtering out unwanted signaling, creation of streams of related signaling and load balancing those streams across processors that will build transactions or otherwise process the data stream. The rules themselves are a descriptive language that describe groups of values, discrete destinations, groups of destinations and the rules that describe a tree of decision points with associated destination lists. The executable module reads the textual rules and builds an in memory structure representing the decision tree expressed in the form of the rules. Data packets, ticks and control packets are sent to the memory structure to be routed to their destination(s) or be discarded as required by the client solutions.

There are many more decision points available than the four that are used in the example. The available decision points cover environmental elements (aspects of the monitoring system itself) and key protocol fields from each of the layers shown in the protocol stack diagram.

Although the routing rules currently deal only with the SS7 protocol stack, they could be extended to allow data packets from other protocol stacks to be routed in a similar fashion. A new decision point, say STACK, could be introduced to allow the decision tree to determine which protocol stack was appropriate for the data packet e.g. SS7 or IP. Other new decision points would allow the decision tree to walk the new stack and discover the upper layers. For example, in a GPRS network when monitoring links that carry information using the IP protocol, decision points could allow the tree to uncover the UDP and GTP layers.

The concept of routing rules is also applicable to higher level data objects that are not themselves part of a signalling protocol

It will further be appreciated that although only one particular embodiment of the invention has been described in detail, various modifications and improvements can be made by a person skilled in the art without departing from the scope of the present invention. For example, alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device.

1. An apparatus for routing information gathered from a telecommunications network, the apparatus comprising:
a receiving element for receiving messages gathered from a telecommunications network, each message being formatted in a predetermined protocol having at least one field providing data relating to a particular transaction on the telecommunications network and other information relating to that particular transaction;
a message identification module coupled to the receiving element for identifying discrete messages;
a field identification module coupled to the message identification means for identifying said at least one field within each discrete message;
a memory for storing a predetermined set of rules for routing messages according to data within a message;
a routing module, coupled to the memory and to the field identification module, for comparing the contents of said at least one field of a discrete message with at least one of the rules of the predetermined set of rules and for routing the message to one of a plurality of outputs or to no output, depending on a result of the comparison.

2. An apparatus for routing information according to claim 1, wherein said field identification module identifies a plurality if predetermined fields in each message.

3. An apparatus for routing information according to claim 1, wherein said predetermined set of rules defines a plurality of subsets of rules, each subset of rules being for comparison with the contents of a different field in the message.

4. An apparatus for routing information according to claim 1, wherein said routing module carries out the comparison on one or more of the rules in a predetermined order whereby, if a message is routed to an output as a result of a comparison, no further comparisons with further rules are made.

5. An apparatus for routing information according to claim 1, wherein said predetermined set of rules includes a plurality of rules in a predetermined sequence and said routing module compares the contents of the at least one field of a discrete message to a first rule in the sequence and, if the message is not routed to an output as a result of that comparison, compares the contents of the at least one field of a discrete message to a next rule in the sequence.

6. An apparatus for routing information according to claim 5, wherein, if the contents of the at least one field of a discrete message has been compared to all the rules in a sequence without the message having been routed to an output as a result of any of those comparisons, then the message is not routed to any output and is discarded.

7. An apparatus for routing information according to claim 1, wherein said predetermined set of rules defines a decision tree for determining to which one of a plurality of outputs the message is to be routed.

8. A method of routing information gathered from a telecommunications network, the method comprising the steps of:
receiving messages gathered from a telecommunications network, each message being formatted in a predetermined protocol having at least one field providing data relating to a particular transaction on the telecommunications network and other information relating to that particular transaction;
identifying discrete messages;
identifying said at least one field within each discrete message;
storing a predetermined set of rules for routing messages according to data within a message;
comparing the contents of said at least one field of a discrete message with at least one of the rules of the predetermined set of rules; and
routing the message to one of a plurality of outputs or to no output, depending on a result of the comparison.

9. A method of routing information gathered from a telecommunications network according to claim 8, wherein said comparison step is carried out on one or more of the rules in a predetermined order whereby, if a message is routed to an output as a result of a comparison, no further comparisons with further rules are made.

10. A method of routing information gathered from a telecommunications network according to claim 8, wherein said predetermined set of rules includes a plurality of rules in a predetermined sequence and said comparing step comprises comparing the contents of the at least one field of a discrete message to a first rule in the sequence and, if the message is not routed to an output as a result of that comparison, comparing the contents of the at least one field of a discrete message to a next rule in the sequence.

11. A method of routing information gathered from a telecommunications network according to claim 10, wherein, if the contents of the at least one field of a discrete message has been compared to all the rules in a sequence without the message having been routed to an output as a result of any of those comparisons, then the message is not routed to any output and is discarded.

12. A method of routing information gathered from a telecommunications network according to claim 8, wherein said predetermined set of rules defines a decision tree for determining to which one of a plurality of outputs the message is to be routed.

13. A method of routing information gathered from a telecommunications network according to claim 8, wherein said predetermined set of rules defines a plurality of subsets of rules, each subset of rules being for comparison with the contents of a different field in the message.

14. A computer program element, comprising computer readable program code means for causing a processor to execute a procedure to implement the method of claim 8.

15. A computer program element according to claim 14, embodied on a computer readable medium.

16. A computer readable medium, having a program stored thereon, where the program is to make a computer execute a procedure to implement the method of claim 8.

17. A programmed computer, comprising:
a memory having at least one region having a computer program element according to claim 15; and
a processor for executing the computer program element stored in the memory.
